(19) United States
(12) Patent Application Publication
(10) Pub. No.: US 2010/0325058 A1
(43) Pub. Date: Dec. 23, 2010

(54) Organizational Network System and Method

(76) Inventors: Timothy J. Roth, Urbana, IL (US); Anthony G. Roth, Laguna Niguel, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/817,301

(22) Filed: Jun. 17, 2010

Related U.S. Application Data
(60) Provisional application No. 61/268,855, filed on Jun. 17, 2009.

(51) Int. Cl. G06Q 99/00; G06Q 30/00

(52) U.S. Cl. 705/319; 705/14.66

(57) ABSTRACT

Techniques for organizational networking for improving efficiency of organizations at performing various organizational tasks are disclosed. A method of organizational networking automatically updates content in an organizational network based on roles of members within an organizational hierarchy. A technique for creating a new subnetwork based on hierarchies associated with existing organizational subnetworks is also disclosed. An advertising engine distributes ads from a partner entity to members of an organization by way of another member of the organization to avoid direct transmission of third party marketing materials to members. A single electronic calendar is provided for an entire organization and may be updated and shared with other organizations automatically based on roles of members. Techniques disclosed herein increase efficiency for organizations and usability of networking tools for members.

### RELATED APPLICATION

This application claims the benefit of U.S. Provisional Application No. 61/268,855, filed on Jun. 17, 2009. The entire teachings of the above application is incorporated herein by reference.

### BACKGROUND OF THE INVENTION

Computer technology has been used in recent decades to connect people and organizations in various ways. Through computing infrastructure such as the Internet, individuals can exchange content with others both near and far, e.g., via email and websites, both of which may be globally accessible. Electronic discussion boards and chat rooms have been popular since the early days of electronic communications for their ability to bring together around common interests. In recent decades, websites (e.g., sites on the World Wide Web) have gained popularity as a medium for exchange of data. More recently, social networking has become a popular mechanism for maintaining relationships between people, e.g., between friends, family members, acquaintances, business contacts, etc. Through social networking sites and similar applications, individuals can post content (e.g., personal information, text, photos) and view content of others in their network.

Organizations of various kinds have adopted websites and similar technologies to provide information about the organizations to members and non-members. In one configuration that was commonly used in the past, organizations designate a particular person as an administrator entrusted with the duty to post content and keep information updated. If the administrator does not diligently perform his/her administrative duties or cannot be located (e.g., due to having left the organization), organizational site content may become stale.

To remedy the issue of a sole administrator being a single point of failure, many organizations have turned to a decentralized approach in which members may post content on their own. Such an approach has its own deficiencies. The burden of keeping content updated is shifted to members, which may be acceptable when membership and/or content remain relatively static. However, when either is expected to change (e.g., in an organization whose members or leaders are expected to change frequently), such an approach is inefficient.

Additionally, a member who updates his/her “profile” (i.e., any content associated with the member, including personal data, news, photos, etc.) at one site may not wish to re-enter similar information at a multitude of other sites associated with the member (e.g., in the context of other organizations). For example, a member of a fraternity who posts pictures from an event to his local chapter's website might not desire to post the same pictures to the website of the fraternity's national headquarters with which the member is also associated. The member might not wish to go to the trouble of re-posting the content, or he might deem such content inappropriate for the national context.

Similarly, decentralized systems in which members can post their own content typically lack controls for regulating content that might be appropriate for internal viewing (i.e., by members of the organization) but inappropriate for external viewing.

Organizations that have employed networking tools for various organizational functions have typically been greatly constrained in their ability to use technology to facilitate organizational operations. Typically, organizations need to turn to a multitude of service providers (e.g., e-commerce, site maintenance, reporting, membership tracking, etc) that may be connected in an unorganized manner. One result of such fragmentation among service providers is that there is little to no standardization among organizations in terms of an electronic (e.g., website-based) presence. For example, different fraternities that wish to communicate and/or form an association electronically (e.g., share content) are often unable to do so due to differing electronic infrastructures. Even different chapters of a single fraternity may be unable to communicate with each other. Various organizations other fraternities as in the foregoing example have similar problems.

Organizations in this situation often find that a bottleneck develops, in which some organizational processing does occur electronically but in a greatly limited fashion that does not live up to the promise of modern computing technology. In such situations, organizations and members may resort to old-fashioned techniques, such as passing documents around manually to edit content. Techniques for streamlining an organization's ability to collect, process, and disseminate information electronically are desired.

Traditional social networking and other related technologies have also failed to leverage the rich informational structure inherent to hierarchical organizations. Many, if not most, organizations have defined hierarchies of some sort. In fact, nearly everybody is a member of numerous hierarchical organizations. For example, most people are members of colleges (in which they may be students, professors, instructors, teaching assistants, class officers, etc.), fraternities or sororities, sports teams (in which there may be a captain or co-captain), faith-based organizations, professional organizations (having a president, vice president, treasurer, etc.), the military (having a progression of titles), and of course organizations by which they are employed (having innumerable different hierarchical positions). Hierarchical organizations have particular needs and challenges associated with computer-based networking.

### SUMMARY OF THE INVENTION

Embodiments of the invention address the foregoing deficiencies of prior art technologies employed for maintaining connections between people and organizations.

An embodiment is a computer-implemented method of organizational networking. The method includes providing an organizational network including multiple organizations, with a defined organizational hierarchy for each organization. Each organization has a respective subnetwork. The method also includes updating content by a member in a first subnetwork based on a first role of the member in a first hierarchy corresponding to a first organization. Content corresponding to the member in a second subnetwork is automatically updated based on a second role of the member in a second hierarchy corresponding to a second organization including the member.

Updating content in the first and second networks may be based on a role of the member in the first and second organizations and based on the content.

The method may further include creating a third subnetwork including members of the first and second organizations as a function of their roles in the respective hierarchies. The third subnetwork may include only members of the first and second organizations having the same role in their respective hierarchies as the first role of the first member in the first hierarchy.

Another embodiment is a computer-implemented method of organizational networking that includes providing subnetworks for each of at least two organizations, with a defined organizational hierarchy for each organization. A first organization has a first subnetwork, and a second organization has a second subnetwork. The method also includes creating a third subnetwork for members of the first and second organizations. The third subnetwork has a hierarchy based on the respective hierarchies of the first and second organizations.

Another embodiment is an advertising (or notification) engine. The advertising engine includes an organizational network for at least one organization with a defined hierarchy. The advertising engine also has a partner entity, trusted by an organization among the at least one organization, a first advertising distribution module to send an advertisement from the partner entity to a first member of the organization, and a second advertising distribution module to send the advertisement from the first member to a second member of the organization automatically based on respective roles of the first and second members in the hierarchy.

Another embodiment is a computer-implemented method of organizational networking. The method includes providing a single electronic calendar for an entire organization. The calendar provides information regarding upcoming events to members of the organization based on a role of each member. The calendar is updated based on content provided by one of the members. The information may be provided to at least one of the members of the organization based on a role of the at least one member within a committee or subgroup of the organization.

The calendar may be shared with a second organization to enable members of both organizations to view and make updates to common content based on roles of the members.

The calendar may be updated automatically based on historical data of the organization. Updating the calendar automatically may be based on events occurring with known periodicity within the organization.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of an embodiment of the invention for propagating content in an organizational network.

FIG. 2 is a network diagram of an embodiment of the invention for forming a new subnetwork aggregating members at a given hierarchical level in an organizational network.

FIG. 3 is a block diagram of an embodiment of the invention for proactively updating content in an organizational network.

FIG. 4 is a network diagram of an embodiment of the invention for creating a new subnetwork based on hierarchical information in existing subnetworks.

FIG. 5 is a network diagram for a notification engine utilizing the structure of an organizational network in accordance with an embodiment of the invention.

FIG. 6 is a computer network environment in which embodiments of the present invention are implemented.

FIG. 7 is a block diagram of a computer node in the network of FIG. 6.

FIGS. 8A-B are organizational diagrams of an organization used in accordance with embodiments of the invention.

FIGS. 9A-C are interaction diagrams showing interactions relating to network permissions in accordance with embodiments of the invention.

FIG. 10 is a block diagram of an embodiment of the invention.

### DETAILED DESCRIPTION OF THE INVENTION

A description of example embodiments of the invention follows.

Embodiments of the invention shift the focus of networking from individuals, as in conventional social networking, to organizations, specifically organizations with defined hierarchical structures. By directing emphasis to the organization as a unit, embodiments provide benefits in the areas of content updating and validation, connection maintenance, administration of organizational duties, and marketing, in ways that are described below. Briefly, embodiments take advantage of the information present in the roles of members in a hierarchy (and the information present in the levels of the hierarchy) to determine how to process information in new and efficient ways.

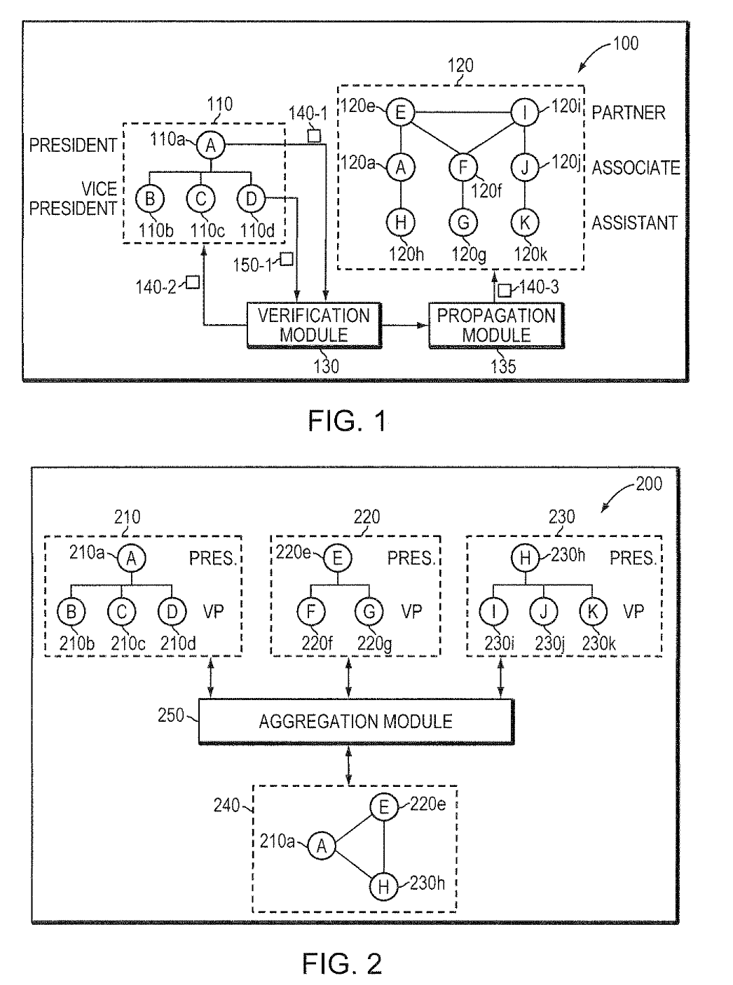

FIG. 1 is a network diagram of an embodiment of the invention for propagating content in an organizational network. Content may include photos, video files, text files, spreadsheet files, audio files, calendar events, board posts and general information about themselves and the like. Organizational network 100 includes subnetworks 110 and 120 corresponding to different hierarchical organizations. Subnetwork 110 (or equivalently, organization 110) has members A, B, C, and D, designated 110a, 11b, 110c, and 11d, respectively. Member A is the president of organization 110, and members B, C, and D are vice presidents. Organization 120 ha a different hierarchical structure in this example (although it need not be different), with partners, associates, and assistants. Partners E and I are designated 120e and 120i; associates A, F, and J are designated 120a, 120f, and 120j; and assistants H, G, and K are designated 120h, 120g, and 120k. Member A is both the president of organization 110 and an associate in organization 120.

To update content, President A sends a message 140-1 to a verification module 130. Message 140-1 may include content as well as identifying information such as a hierarchical level, associated role, and/or security level of President A 110a in organization 110. Based on message 140-1, the verification module 130 updates President A's profile at a website (or other display medium) for organization 110 via message 140-2, assuming that President A 110 has appropriate privileges within organization 110 and that the content is approved by the standards of organization 110 (e.g., is not objectionable content). The verification module 130 also propagates the content to the profile of Associate A 120a at organization 120 in the form of a message 140-3 sent via a propagation module 135. A similar request 150-1 to update content of Vice President D 110d is denied by verification module 130 based on the content of the message and the role of D in organization 110.

Through the foregoing mechanism, members may update their content in a straightforward fashion without having to duplicate their efforts at other sites at which they are members. In contrast, prior art techniques have required individuals to manually update their profiles at multiple (different, disparate, etc.) sites. The details of content updating according to embodiments of the present invention are provided below in a later section. Additionally, organizations have control over the content posted to their sites by members. Organizations may have different controls to determine if content is visible internally or externally. For example, content of President 110a may appear in one form to members of organization 110, in another form to members of organization 120 to which A also belongs, and in another form (or not at all) to external entities.

Hierarchical organizations may wish to maintain associations with other hierarchical organizations in complex manners, e.g., by permitting only certain types of content to shared between certain members at varying hierarchical levels. For example, it may be desirable to facilitate communication between the presidents of respective organizations. According to prior art techniques, a separate group may be formed, but existing presidents may not know about such a group, and it is not clear who may administrate such a group (e.g., regulates content for such a group). According to popular contemporary social networking sites, multiple organizations (groups) may be formed, e.g., members of a college class year. It is not clear in such prior art systems which group is the “authentic” group, and membership may be diluted for this reason. Additionally, the prior art does not provide mechanisms for informing members of newly formed groups in which their membership may be desirable.

FIG. 2 is a network diagram of an embodiment of the invention that addressing the foregoing deficiency of the prior art by forming a new subnetwork that aggregates members at a given hierarchical level in an organizational network. Organizations 210, 220, and 230 in an organizational network 200 have respective presidents A 210a, E 220e, and H 230h and respective vice presidents (B 210b, C 210c, D 210d), (F 220f, G 220g), and (I 230i, J 230j, K 230k). An aggregation module 250 gathers data from the various organizations 210, 220, 230 to create a new subnetwork 240 including presidents A 210a, E 220e, and H 230h. Presidents A 210a, E 220e, and H 230h may receive invitations to join the new subnetwork 240 in an embodiment; in another embodiment, they are automatically added. Aggregation may be manually initiated, e.g., by one of the presidents or by another member of an organization 210, 220, 230 based on a hierarchical role of the member, or may be automatic, e.g., initiated upon a certain scheduled event or trigger event. In some embodiments, members of more than one role are aggregated, e.g., all the officers may be pooled together.

In some embodiments, roles used for aggregation may be dynamically assigned, logical roles as opposed to static, physical roles. For example, a committee may be formed (by an administrator, by individual members of an organization, or by some combination thereof) with roles assigned to committee/team members. Such roles provide a logical overlay upon the actual physical roles of the members within the organization. In this way, committee members may have roles flexibly assigned, and permissions associated with such roles may be used to update content in an organizational network. Information pertinent to the committee (e.g., milestones, status reports) is instantly propagated to appropriate members within the organization, e.g., committee members and superiors in the hierarchy.

By providing the foregoing aggregation techniques, embodiments of the invention simplify group maintenance tasks for organizations. It is no longer necessary for an individual to manually locate potential members individually to invite them, nor is it necessary for potential members to search for potential groups. In one embodiment, a new president of an organization who may be unfamiliar with administrative procedures is automatically notified of a group for presidents to which he/she should belong, which may help bring the president up to speed.

By propagating updated content throughout an organizational network and enabling new association functionality (e.g., aggregation) as described above, embodiments provide new types of communications and coordination functionality to organizations. For example, an embodiment of the invention provides a new networked calendar. A single calendar is provided for an entire organization, and individual users (members) see events based on their roles within the organization. In an embodiment of the invention, a networked calendar is shared across multiple organizations. For example, an organization may hold an event that shows up on the calendar of both that organization and a partner organization. In this way, updates to a single calendar may be propagated throughout an organization and to partner organizations in a simple, efficient manner, eliminating the need for multiple organizations to maintain separate, respective calendars or to update calendars manually.

Updates to a calendar may be member-initiated, i.e., manually requested, or they may be automatically generated based on historical data of the organization. In some embodiments, recurring organization events, e.g., annual elections of officers, are automatically detected based on past historical data. In some embodiments, new members, e.g., a newly elected president, are automatically notified of expected events based on past historical data, e.g., fundraisers that are held each year after elections. In this way, administration of recurring tasks is simplified for new organizational members.

Content related to a calendar or any other content may be accessible based on different roles of users/members in a hierarchical organization. In one embodiment, permission levels on differing roles, with content marked as being at one of the following levels: public, private, group/subgroup/committee, or hidden group. Content marked as public is accessible to anyone, e.g., members within the organization as well as external non-members. Content marked as private is only accessible to other members of the organization. Content marked as group/subgroup/committee is only accessible to designated group/subgroup/committee members. Content marked as hidden is only accessible to members of the so-called hidden group, with others not even knowing of the existence of such content.

Sharing of Calendars may be implemented vertically through multiple levels of a hierarchal organizations (networks) with specific individual roles of members delineating permission of entering, editing, viewing and sharing calendar entries being built at each level (National, regional, state, local or similar structures) of the hierarchy of the organizations.

Additionally, for each organization within the network, the calendar sharing with other organizations in the network may be horizontal or vertical (up/down) based on the respective level of each organization in the network. Sharing done upward or horizontally cannot be forced on the organization desired to receive sharing but only submitted for acceptance, while sharing downward from a higher level organization (from vertical network) can be forced upon lower organizations (e.g., from a parent organization to the parent organization's subnetworks).

Organizations who are in more than one network may control calendar entries similarly for each network.

Organizations may also specify roles/permissions for internal “groups/committees” (like individual roles/permissions), including roles/permissions within each group for calendars designated within the group. Groups may also include members from all organization within Networks.

Additional networks may be created anytime within the entire network community to include at least two organizations (including sub networks within hierarchal networks.

It should be noted that the principles of sharing a network calendar may also apply to sharing web pages, events, news items, forums and will extend to all tools.

Embodiments also support an organization's standardization efforts through organization-centric subgrouping functionality. For example, subgroups that are created with organizational approval as in embodiments of the present invention enable an organization to maintain control of its brand image and present a unified view of the organization to the external world. In prior art grouping/subgrouping systems that do not use organizational networking principles as in present embodiments, invitees to a group/subgroup can invite others, potentially leading to loss of control over membership in the group/subgroup. In contrast, embodiments of the present invention tie group/subgroup membership to roles in an organization, e.g., through public/private/committee permission levels. Accordingly, group members can be confident that all other group members have been vetted properly and that the group is approved by the organization.

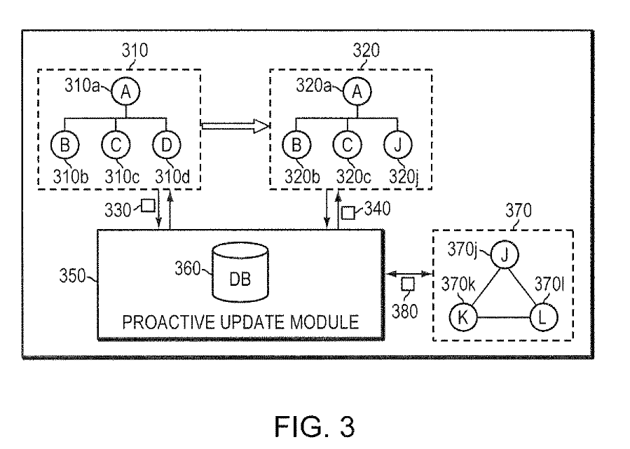

FIG. 3 is a block diagram of an embodiment of the invention for proactively updating content in an organizational network. Organization 310 has members A 310a, B 310b, C 310c, and D 310d at a certain point in time. At a later point in time, the organizational makeup has changed, and the new organization (labeled organization 320) has members A 320a, B 320b, C 320c, and J 320j; thus, D 310d has been replaced by J 320j. Whereas prior art systems would have a blank profile for J 320j until he/she provided profile information, an embodiment of the invention supplies profile information for J 320j automatically (proactively, without user input) using a proactive update module 350 based on another profile of J 370j in another organization 370 (having members J 370j, K 370k, and L 3701) and the role of that member within the organizations 320 and 370. The proactive update module 350 has a database 360 that maintains historical information regarding profiles and membership in the various organizations 310/320, 370 by means of messages 330, 340, and 380.

Traditional prior art methods for forming a subgroup (subnetwork) have resulted in a flat structure (at least initially) lacking the hierarchical information of the existing organizations. For example, a traditional method of forming a subnetwork has been to form a new group and invite members of existing organizations to the group. By doing so, much of the rich organizational information regarding hierarchy have traditionally been wasted.

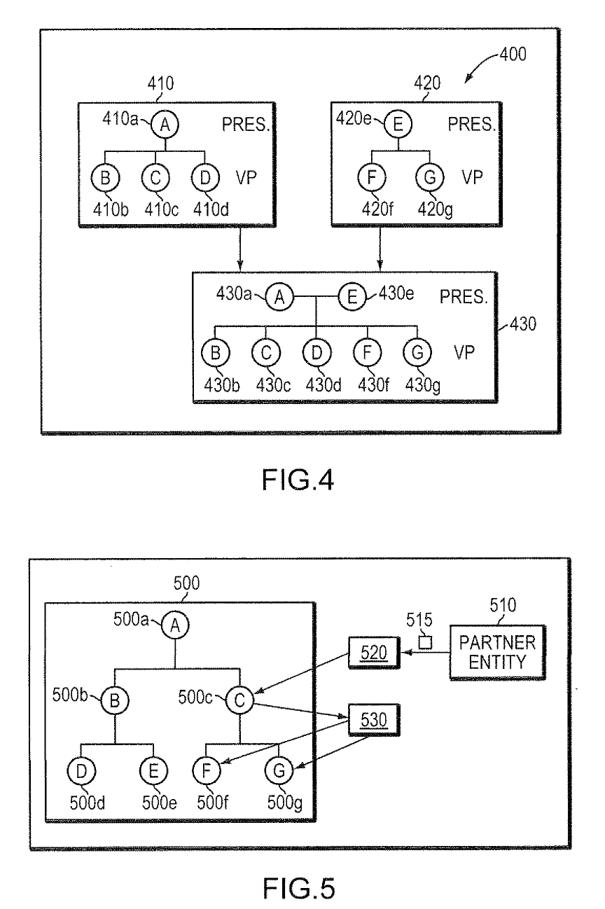

FIG. 4 is a network diagram of an embodiment of the invention for creating a new subnetwork based on hierarchical information in existing subnetworks. Organizational network 400 includes organizations 410 and 420, having respective members (A 410a, B 410b, C 410c, D 410d) and (E 420e, F 420f, G 420g). A new subnetwork 430 is created having the members of the existing organizations 410 and 420 and preserving respective hierarchical structure of the existing organizations. In this example, all the members of organizations 410 and 420 are present in organization 430, although that need not be the case. Although only a single level of hierarchy and only a single degree of separation are shown for simplicity, subnetworks may preserve hierarchical information regarding multiple degrees of separation. Such subnetworking capabilities are useful when multiple project teams join together for an integration effort or when companies merge, for example. By preserving hierarchical structure in the newly formed subnetwork, communication is enhanced and expedited.

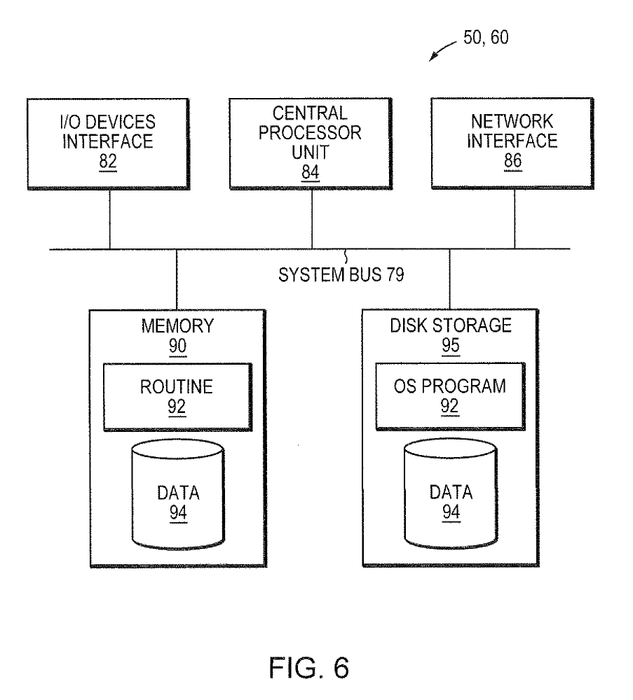

FIG. 5 is a network diagram for a notification engine utilizing the structure of an organizational network in accordance with an embodiment of the invention. In one embodiment, the notification engine is used to deliver advertisements and is thus an advertising engine. Traditional advertising techniques related to social networks and/or organizations have entailed third-party communications to individuals. Such communications are often interpreted as unsolicited spam. An embodiment of the invention as in FIG. 5 addresses that problem. In FIG. 5, an entity 510 (termed a partner entity or a trusted entity) has a trusted relationship with an organization 500 that has members A, B, C, D, E, F, and G, designated 500a-g, respectively. Partner entity 510 sends an advertisement 515 to a member (in this case, member C 500c) via a first advertising distribution module 520. Member C 500c then routes the advertisement to members F 500f and G 500g via a second advertising distribution module 530 based on the organization 500—defined hierarchical relationship between the members. Thus, member C 500c in the above example serves as a marketing proxy or agent for partner entity 510. In this way, third party advertisers are not directly contacting (initiating communication with) members of an organization 500. In other embodiments, the foregoing techniques involving a partner entity are used to deliver other types of messages not involving advertisements.

The advertising distribution modules 520 and 530 may be configured in different embodiments to route advertisements through member C 500c automatically or upon some input from member C 500c, e.g., addition of a personalized or event-themed message. In some embodiments, C 500c may deny distribution of certain advertisements. Advertising distribution modules 520, 530 may employ email techniques.

By harnessing a trusted relationship between the partner entity 510 and the organization 500, advertisers are more likely to reach their target audience with the desired outcome, and organizations 500 and members gain the benefit of reduced/minimized spam or unwanted third party solicitation. In some embodiments, organization 500 benefits from the relationship with the partner entity 510, e.g., by receiving compensation for every advertisement or for every advertisement that results in a purchase.

Organization Validation

In embodiments of the invention, organizations have to be validated before they are granted access to the resources of an organizational network. Validation occurs in an initial phase during which the organization presents credentials to a system manager (validation authority). For example, the organization wishing to join the network may be an affiliate of an existing member organization (i.e., of an organization already in the organizational network). After a new organization has been validated, the system manager sets up an electronic infrastructure for the organization, including default profiles for the organization and/or for members of the organization in some embodiments. The profiles include indication or designation of organizational hierarchy levels, roles, security/permission levels per role, etc. By requiring an initial validation phase before allowing a new organization to join the network, embodiments of the invention enhance trust in amongst members and ensure that only controlled interactions between organizations and members occur in defined ways according to organizational hierarchies.

Content Updating

Embodiments of the invention provide a simple way for members in an organization to update (upload) their content to a common repository that is shared across an organizational network. The repository is web-based in some embodiments. Initially, a member creates a new page (e.g., web page) or choose an existing page (e.g., his/her own page or one pertaining to the organization as whole) to modify. The member adds or edits text (e.g., using a standard word processing application), images, files, links, or custom forms. Then, the member saves and publishes the update. Based on the content and/or the role of the member within the organization, the update may be processed within the organization's subnetwork or denied, and the update may be propagated to other subnetworks corresponding to other organizations to which the member belongs, as discussed above.

Prior art content management systems (CMS's) included complicated content updating procedures that typically required a user to access a separate website to update content. For example, users of such prior art systems who wished to make an update to a first site typically had to access a second site to edit content and save changes before the update would be published to the first site. In contrast, embodiments of the present invention employ a “one-click” technique whereby a user may update content directly on a site and have the changes propagated immediately throughout an organizational network. For example, a user may use a single mouse click to insert a form (e.g., a calendar form) into a website corresponding to an organization. In another example, a user may insert a web control involving text entry and may use standard word processing tools that are provided inline (directly on the web page) to edit content.

The member does not need to have special knowledge of HTML or any programming language, although content (e.g., web forms) may me modified using HTML in some embodiments to supplement “one-click” functionality. Web development applications and file transfer protocol (FTP) clients are not needed either. Embodiments provide capabilities to upload images without requiring any image editing software on the part of the member of the organization.

By providing novice users as well as administrators a streamlined approach for updating content, embodiments of the invention increase efficiency and efficiency for organizations and individual users.

Electronic Commerce

Embodiments integrate e-commerce functionality directly into the organizational network to enable organizations to concentrate on core organizational tasks rather than ancillary commercial overhead. As one example, embodiments enable inter/national organizations to manage convention and seminar registration through online forms. Members register and pay online, e.g., using payment mechanisms as are known in the art of e-commerce, and the submitted information and payment go directly to the inter/national organizational headquarters to be integrated with a database system without extra time or paperwork.

Embodiments enable organizations that solicit member donations to accept such donations (payments) directly through an integrated online secure payment system. The electronic framework of the organizational network increases trust for members by building on the existing structure of organizations.

Embodiments integrate reporting tools directly into an electronic commerce framework. For example, embodiments aggregate data within and across organizations to provide targeted informational views. In example scenarios, an organization may wish to know which member or local branch donated the most money or sold the most tickets to an event. By linking various parts of an organization together electronically, embodiments provide such information by employing database storage and retrieval techniques. With an organization-centric (rather than individual-centric) view, information regarding recurring events in an organization is efficiently categorized and reported. An organization can use embodiments of the invention to learn the ramifications of recent e-commerce transactions throughout the organization and even share such information with other organizations in a common framework.

Modules

An embodiment of the invention provides distinct modules that may be provided to users (e.g., organizations) for different services. For example, an electronic recruitment (e-recruitment) module is provided to enable an organization to perform recruiting functions in an electronic manner that is integrated with other organizational functions (e.g., administration, e-commerce). Modules according to embodiments of the invention enable organizations to operate more efficiently by reducing their burden on non-core tasks. Modules may also enable organizations to operate profitably where they could not before. For example, an organization that formerly operated essentially in a non-profit mindset may find that e-recruitment or other modules enable significant cost savings that translate into profitability.

Advantages

Embodiments of the invention enable organizations to maintain a consistent, professional web presence across multiple chapters (e.g., local/national/international) in a scalable manner.

By streamlining communications, administrative tasks, operations, and marketing, embodiments of the invention address two core needs of any organization: increasing participation by/with members and raising money. By relieving the administrative and operational burden faced by many small organizations (e.g., churches and non-profit organizations), embodiments allow those organizations to use technology to their advantage in a simple, scalable manner. Organizations are enabled to perform functionality that previously was not possible in any automated or efficient way, e.g., electronic collection of dues and organization-wide notification of events. By providing hierarchical organizations with a set of tools for accomplishing more in a better way online, embodiments of the invention enable organizations to leverage their inherent hierarchical structure to improve scalability for present and future operational goals.

In contrast, prior art technologies do not provide standardized tools for streamlining the foregoing organizational tasks. According to prior art techniques, even if one branch of a non-profit organization manages to implement a system for electronic member management, for example, other branches are left to solve the problem anew, and information is not shared between them.

Example Implementation

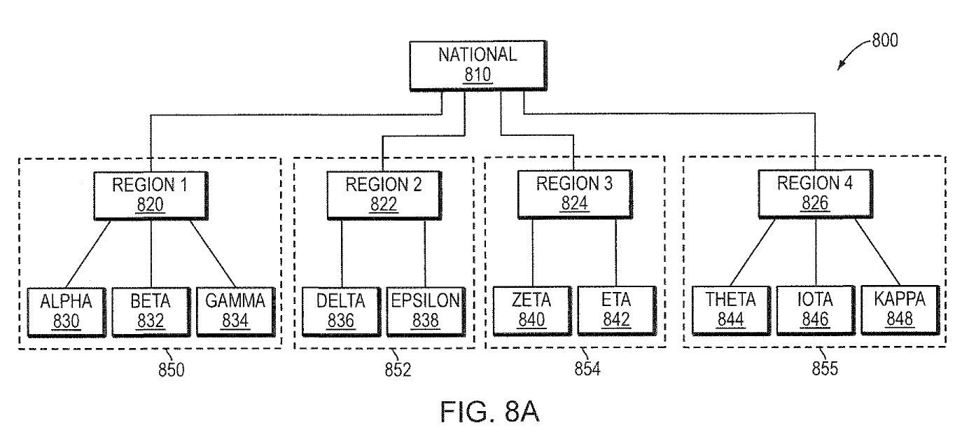

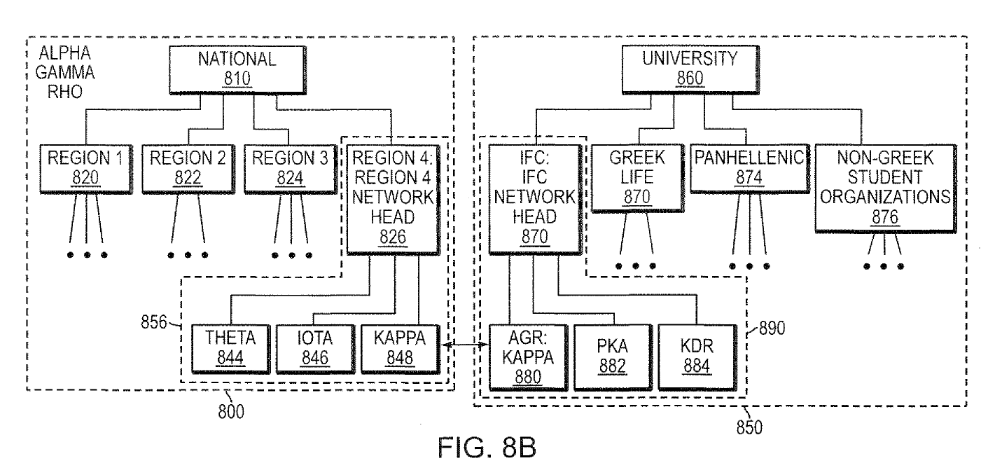

An example implementation is as follows. FIGS. 8A-B describe example organizations in accordance with embodiments of the invention. In FIG. 8A (prior art), an organization is shown with three levels. This hierarchy may correspond to a fraternity, e.g., Alpha Gamma Rho (AGR). Other organizations may be used as well; a fraternity is shown by way of non-limiting example. A national body 810 is at level 1, with regions 1-4 (820, 822, 824, and 826) at level 2 and chapters Alpha 830, Beta 832, Gamma 834, Delta 836, Epsilon 838, Zeta 840, Eta 842, Theta 844, Iota 846, and Kappa 848 at level 3 corresponding to particular regions as shown in FIG. 8A. The entire AGR organization has an organizational network 800, and the regions have corresponding regional networks 850, 852, 854, and 856.

FIG. 8B shows an example interaction between the AGR organization and another organization (a university organization 850) according to an embodiment. The university 860 has various sub-organizations or groups: Inter-fraternal Council (IFC) 870, Greek Life 872, Panhellenic council 874, and non-Greek student organizations 876. This categorization of sub-organizations is for illustration only and may differ. The Inter-fraternal council 870 in turn has associations with Alpha Gamma Rho's Kappa chapter 880 as well as with other fraternities Pi Kappa Alpha (PKA) 882 and Kappa Delta Rho (KDR) 884, in particular with corresponding chapters thereof (not labeled explicitly). The IFC suborganization forms regional network 890.

Embodiments of the invention enable the Kappa chapter 880 of Alpha Gamma Rho (within the university organization 850) to share profiles and other information (as shown by a bidirectional arrow in FIG. 8B) with the Kappa chapter 848 within the AGR organization 800. In this way, information may be kept up-to-date in multiple locations, and administration across an organization and multiple organizations is simplified in a manner not possible via prior art techniques.

Other sharing relationships are possible than the share between AGR Kappa chapters 880 and 848. For example, Kappa chapter 880 could decide to share content with any member (or subgroup) within the university organization 850, e.g., with Greek Life 872, but only content pertaining to the Kappa chapter 880 could be shared, and that could only be shared based on permissions (e.g., based on approval by the national body 810 or generally based on verification as in FIG. 1).

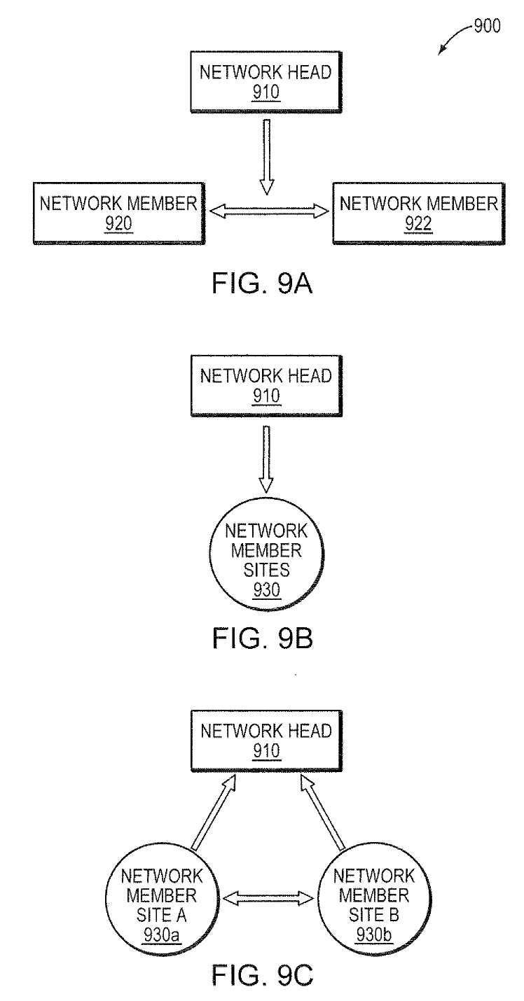

FIG. 8B shows “network heads” of Region 4 826 and IFC 870, respectively. The network heads are further described in FIGS. 9A-C in the context of network permissions. As shown in FIG. 9A, a network head 910 can view and manage all member profiles (i.e., is a manager for a network or organization). Furthermore, network head 910 can choose whether or not all members (e.g., network member 920 and network member 922 in FIG. 9A, and more specifically, members from different chapters, organizations or associations) can view and/or interact with each other. By regulating permissions in this way, content on an organizational network can be distributed as broadly or narrowly as desired, lending flexibility to a network head's 826, 870, 910 capability to share content.

FIG. 9B shows that a network head 910 can edit pages, add files, add photos, add events, add news, and/or add forms to network member sites 930, and these changes and/or additions are automatically approved in an embodiment.

FIG. 9C shows that in an embodiment, member sites (e.g., network member site A 930a and network member site B 930b) can submit photos, files, events, news, and forms to their corresponding network heads' sites. Such content is displayed in an embodiment upon approval by that network head 826, 870, 910. As shown by the horizontal arrow in FIG. 9C, upon approval by a network head, members (e.g., 930a and 930b, who might be from different chapters) can interact with each other. Specifically, in an embodiment, such different members can view each other's profiles as well as submit photos, files, events, news, and forms to other sites that can be displayed pending approval by an administrator/head/manager of the other site.

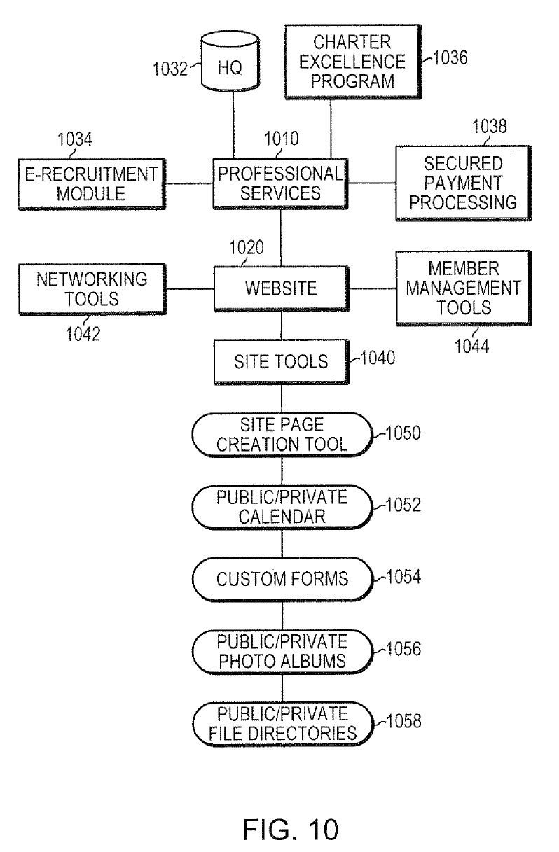

FIG. 10 is a block diagram of an embodiment of the invention. The example system architecture in FIG. 10 can be used to implement the functionality of FIGS. 1-5 among other functions. A website 1020 is regulated by a professional services module 1010, and various modules that provide tools, such as site tools module 1040, networking tools module 1042, and member management tools module 1044. The website 1020 may be an Internet website or another electronic site that is capable of providing/displaying content. The professional services module 1010 is connected to a database 1032 (e.g., associated with headquarters of an organization) and various functional modules such as an e-recruitment module 1034 and a secured payment processing module 1038. The database 1032, which may be implemented as one or more databases, stores information on a per-organization basis in an embodiment and is used by various system components. For example, the verification module 130 of FIG. 1 accesses the database to determine relevant permissions and content update privileges. The database 1032 includes the profile/member history database 360 of FIG. 3 in an embodiment and may be used to store data for the networked calendar described earlier.

In an embodiment, the networking tools module 1042 includes the propagation module 135 and verification module 130 of FIG. 1, which also accesses the database 1032 to achieve content updates.

In an embodiment, a chapter excellence program module 1036 provides an ability to track local chapter (subgroup) progress based on certain criteria and rank various chapters, e.g., on an annual basis, for awards.

The e-recruitment module 1034 allows an organization (e.g., an organization that is a client of an organizational networking system according to an embodiment of the invention) to grow its membership base efficiently online. For example, content associated with high school seniors can be processed and checked for potential matches with interested organizations, such as college fraternities. Such fraternities, which seek to recruit new members, appreciate receiving lead information about qualified candidates, and the high school students appreciate learning about fraternities, which is a mutually beneficial situation. Thus, dissemination of member information across organizations leads to efficiency gains for various parties. In some embodiments, the e-recruitment module 1034, in conjunction with the database 1032 and the networking tools module 1042, is used to implement the aggregation and hierarchical subnetworking functionality of FIGS. 2 and 4.

The secured payment processing module 1038 allows an organization to bill, collect, and report on billings/collections online while allowing the organization to keep a record of each member's financial history with the organization. The secured payment processing module 1038 is “siloed” in the sense that it is kept separately from the external world and not exposed to others, unlike prior art electronic payment systems. In an event of a hacker gaining unauthorized access to the secured payment processing module, client data or sensitive transaction data are not exposed, for increased security. The payment processing module 1038 may be linked to the advertising engine (notification engine) of FIG. 5 in some embodiments to tie ads and subsequent transactions together. The database 1032 is also used in the context of transactions to store transaction history for each member.

Furthermore, embodiments of the invention provide a fully integrated approach for organizational networking that is not dependent on external networking tools (e.g., traditional social networking tools). Providing a fully integrated solution ensures that data of organizations and members will not be provided to external entities (e.g., third party marketers) in an embodiment.

The database 1032 (e.g., associated with headquarters) provides an ability to segment membership data based on particular data fields and combinations thereof for marketing, fundraising, and member management. The database 1032 also allows an organization to keep detailed, up-to-date, and completely editable records (information) for each member.

Various site tools are shown in site tools module 1040 of FIG. 10. The site page creation tool module 1050 provides public/private page creation and a content management system (CMS) in an embodiment of the invention. A public/private calendar 1052 as described above enables maintenance and display of public, member-only, group, and private events. Such events may only be visible to individuals with an appropriate role (e.g., logged-in members, logged-in members of a group or committee, etc). Custom forms (electronic forms) 1054 are provided for registrations, surveys, job advertisements, scholarships, and various functions, which may be specific to an organization. Such custom forms can be added directly to a website (via a “one-click” methodology as described above) to simplify processing.

Member management tools module 1044 enable addition, removal, and/or approval of members, and viewing and/or editing of member profile information in embodiments of the invention. Verification module 130 and propagation module 135 are employed by member management tools module 1044. In an embodiment, such tools also enable member information to be exported, e.g., from the database 1032 to a convenient format such as a comma separated values (CSV) file, another text file, a binary file, or a spreadsheet. In an embodiment, such tools also enable creation of custom roles for members (e.g., on a committee within an organization) and the assignment of permissions to these roles. Such permissions determine what members or groups of members can and cannot do on a site.

Case Study

A case study is presented below to indicate an example usage of embodiments of the invention by a client organization. During an initial consultation process, a new client organization meets with a system manager (manager of the organizational network) and indicates which professional services (e.g., e-recruitment) are of interest to the organization. After the organization's credentials are validated (e.g., recognition of the organization as a trusted organization), network information for the organization is configured. For example, a website is setup on servers of the organizational network system based on, for example, uniform resource locator (URL) and/or domain name service (DNS) information of the organization's web presence.

Once initial site design is approved by the client organization, a member list may be uploaded to the site. The client is then enabled to create and edit content on the front end (interface to the external world) and the back end (databases, infrastructure-associated elements) of the website.

Example Computer environment

FIG. 6 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

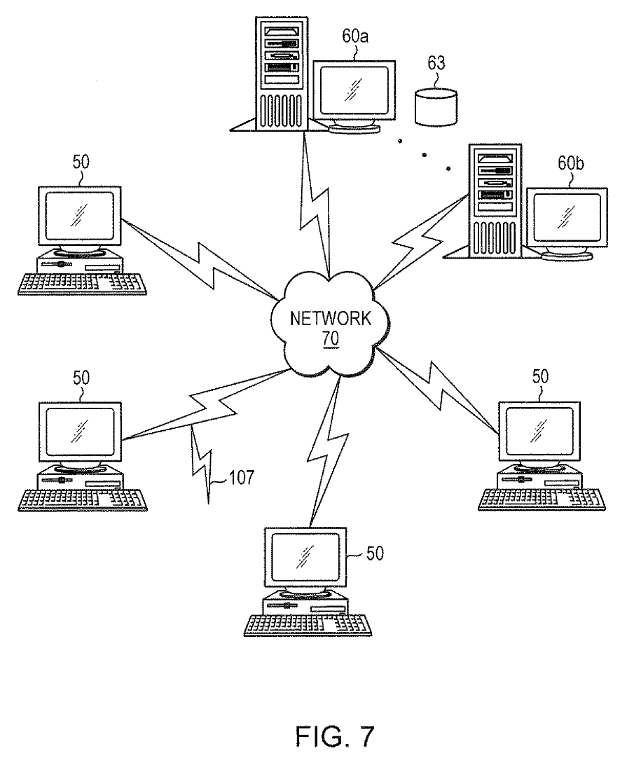

FIG. 7 is a diagram of the internal structure of a computer (e.g., client processor/device 50 or server computers 60) in the computer system of FIG. 6. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 6). Memory 90 provides volatile storage for computer software instructions 92 and data 94 used to implement an embodiment of the present invention (e.g., processing associated with verification module 130, propagation module 135, aggregation module 250, proactive update module 360, subnetworking of FIG. 4, distribution modules 520 and 530, and the modules, services and website of FIG. 10, for example). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

For example, the present invention may be implemented in a variety of computer architectures. The computer network of FIGS. 6 and 7 are for purposes of illustration and not limitation of the present invention.

While this invention has been particularly shown and described with references to example embodiments thereof, it will be understood by those skilled in the art that various changes in form and details may be made therein without departing from the scope of the invention encompassed by the appended claims.

Appendices are presented below with further details of embodiments of the invention. The appendices are presented by way of non-limiting examples.

Appendix A contains information about example organizations in accordance with embodiments of the invention.

Appendix B contains details about network features in accordance with embodiments of the invention.

Appendix C contains details about website platform components in accordance with embodiments of the invention.

Appendix D contains details pertaining to how a client organization may be setup (configured) in accordance with embodiments of the invention.

Appendix E contains details about website features and client controls in accordance with embodiments of the invention.

What is claimed is:

1. A computer-implemented method of organizational networking, the method comprising:
providing an organizational network including multiple organizations, with a defined organizational hierarchy for each organization, each organization having a respective subnetwork;
updating content by a member in a first subnetwork based on a first role of the member in a first hierarchy corresponding to a first organization; and
automatically updating content corresponding to the member in a second subnetwork based on a second role of the member in a second hierarchy corresponding to a second organization including the member.

2. The computer-implemented method of claim 1, wherein updating content in the first and second networks is based on a role of the member in the first and second organizations and based on the content.

3. The computer-implemented method of claim 1, further including creating a third subnetwork including members of the first and second organizations as a function of their roles in the respective hierarchies.

4. The computer-implemented method of claim 3, in which the third subnetwork includes only members of the first and second organizations having the same role in their respective hierarchies as the first role of the first member in the first hierarchy.

5. A computer-implemented method of organizational networking, the method comprising:
providing subnetworks for each of at least two organizations, with a defined organizational hierarchy for each organization, a first organization having a first subnetwork, a second organization having a second subnetwork; and
creating a third subnetwork for members of the first and second organizations, the third subnetwork having a hierarchy based on the respective hierarchies of the first and second organizations.

6. An advertising engine comprising:
an organizational network for at least one organization with a defined hierarchy;
a partner entity trusted by an organization among the at least one organization;
a first advertising distribution module to send an advertisement from the partner entity to a first member of the organization;
a second advertising distribution module to send the advertisement from the first member to a second member of the organization automatically based on respective roles of the first and second members in the hierarchy.

7. A computer-implemented method of organizational networking, the method comprising:
providing a single electronic calendar for an entire organization, the calendar providing information regarding upcoming events to members of the organization based on a role of each member; and
updating the calendar based on content provided by one of the members.

8. The computer-implemented method of claim 7, wherein the information is provided to at least one of the members of the organization based on a role of the at least one member within a committee or subgroup of the organization.

9. The computer-implemented method of claim 7, further including:
sharing the calendar with a second organization to enable members of both organizations to view and make updates to common content based on roles of the members.

10. The computer-implemented method of claim 7, further including updating the calendar automatically based on historical data of the organization.

11. The computer-implemented method of claim 10, wherein updating the calendar automatically is based on events occurring with known periodicity within the organization.
